(19) United States
(12) Patent Application Publication
(10) Pub. No.: US 2004/0040093 A1
(43) Pub. Date: Mar. 4, 2004

(54) Weed-grabber

(76) Inventor: Gregory Y.C. Lee, London (CA)

Correspondence Address: GREGORY Y.C. LEE, APT 303, 1582 ERNEST AVE, LONDON, ON, N6E 254, CA

(21) Appl. No.: 10/232,369

(22) Filed: Sep. 3, 2002

(51) Int. Cl. A01B 1/00

(52) U.S. Cl. 7/114

(57) ABSTRACT

Weed-Grabber a multifunction hand operated garden tool device equipped with semi-automatic gabbing clamp mechanism positioned over a 6 inches long cutting blade for deep ground penetration sporting wide T-shaped cutting blade tip to cut and grab all kinds of weeds from small inch size buds to several feet full-grown plants with some roots several inches thick and vines. Long cutting blade length provides means to work the soil and also by simple twisting it can pulverize weed roots left in dirt after each cutting as well. Motion of the Clamp is derived either from a manual release-handle and/or as the cutting blade penetrates the ground the clamp opens and it closes when the blade comes out. And multiple weeds can be removed at once plus it comes with attachment tool heads. Grab-clamp design of this tool allows picking up loose yard debris as big as an army boot and handy for reaching into flower beds.

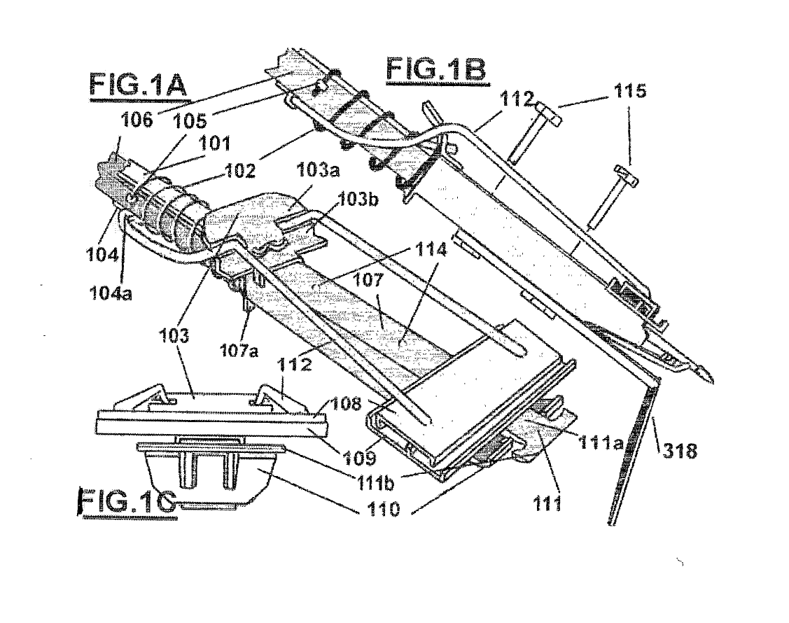

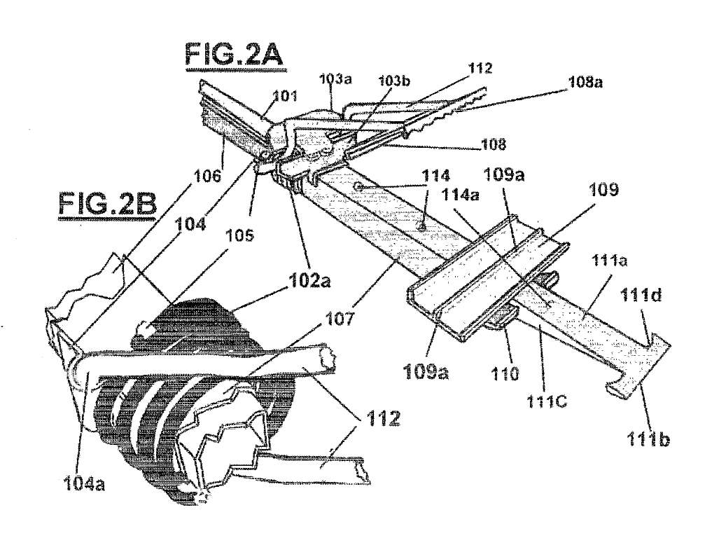

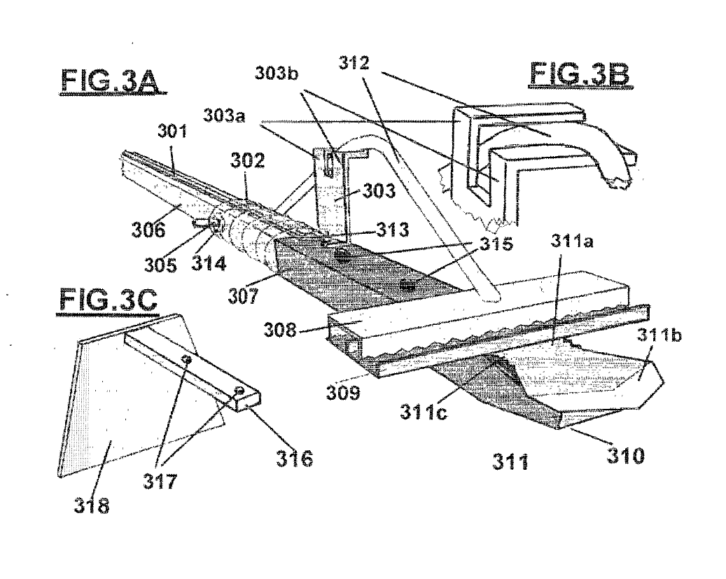

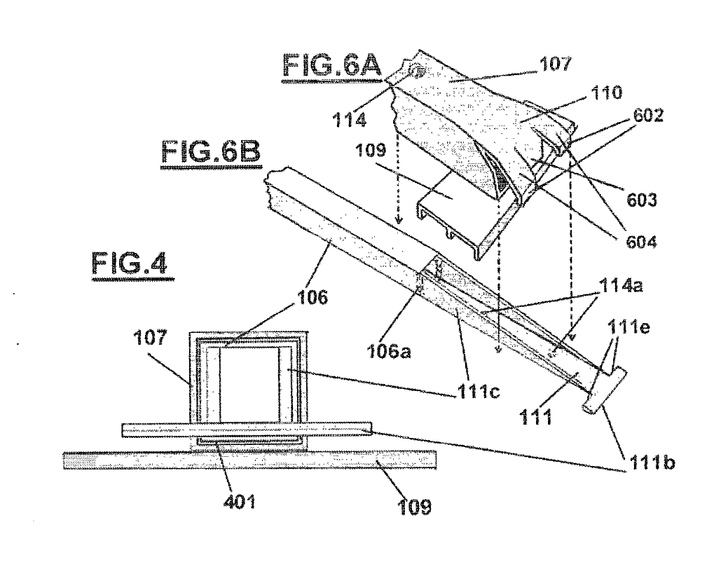

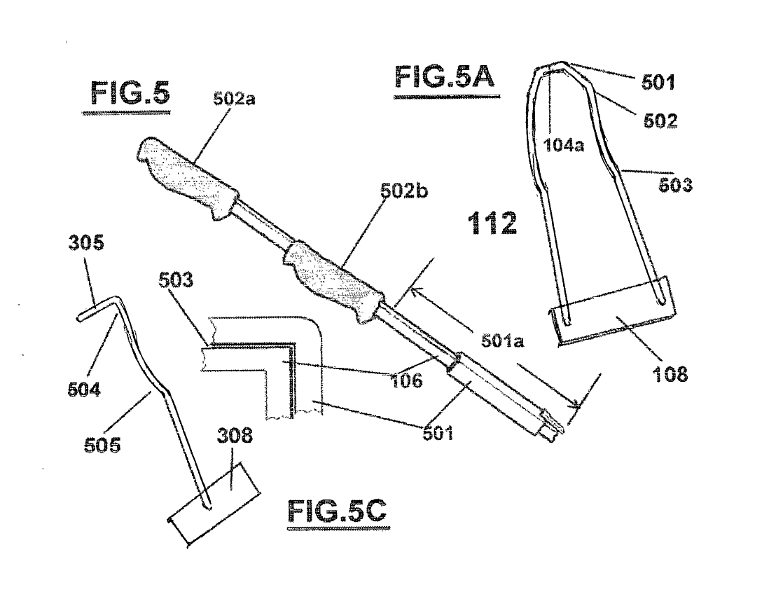

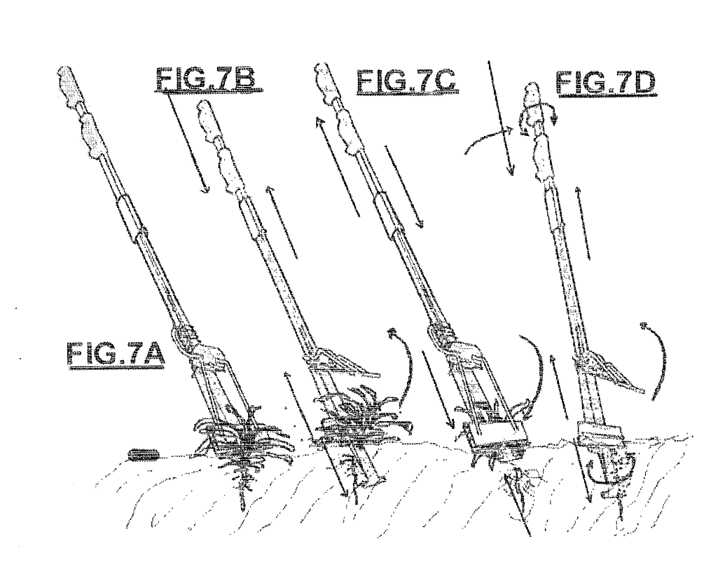

### FIELD OF THE INVENTION

This invention relates to a manual hand garden tool with automatic levered clamping feature for grabbing objects out of arms reach and its function further enhanced by manual hand control and made for performing hands-off removal of plants considered as weeds, growing in flower beds or gardens and removal of any other yard debris.

The long tool handle allows for working in most comfortable position standing up or otherwise. The length and tip width of the blade is suitable for cutting away the most stubborn weed or other plants small and big, with various root systems from thick and wide growing over the ground surface or thin and long growing deep into the ground and remove these unwanted vegetations with minimum damage to the soil around it.

The garden tool is tough and light enough and yet functional to simplify the process of removing weeds found growing abundantly everywhere in the hot summer weather on mostly dry and hard soil conditions. Combination featuring: manual and automatic clamping with large open cavity helps grab loose weeds and debris large and small.

As a garden tool, it incorporates multi-functionality even further to facilitate gardening works by four folds.

First: The, blade itself can be used for poking or picking or cutting or slicing or working the soil by pulling back on the blade cover through handy release handle to expose the long blade.

Second: There is a clamp mounted on the blade cover connected to a manual hand control for catching or grabbing or holding objects and other yard debris or trashes

Third: Let the tool work for you by using it the way it is with blade working automatically and interactively in combination with the clamp that can be intercepted by manual hand control.

Fourth: Other attachments can be added on to it to turn it into a gardenhoe or rake or planter or any other tools for garden or otherwise.

The tool comes in variety of pole shaft and length suitable for a person to work effectively in a most comfortable posture for the job at hand that makes the weed removal and gardening a pleasure.

### BACKGROUND

Gardening work is not an exacting science. To keep beautifully blooming flower gardens or carpet smooth grass yards is also not an easy work. The nature has it that all living things make use of any given spaces according to its genetic voracity. To which we owe this terrible dilemma of improper vegetations growing exactly where we don't wish having them. The end result being forced labor on our part to keep certain plant species in homogenous groupings appealing to our taste and economics and all others species finding themselves in our long list of pest and weeds.

Typically, those unwanted weed plants have vigorous growth usually outpacing those precious varieties we want to save thereby forcing us to take several drastical measures to have them removed. Historically all gardening therefore was based on manual care taking. Over times, with forward increasing technology developments and conversely shrinking personal available time we found ourselves following closely approaches that are ultimately very destructive and poisonous by resorting to motorized machineries that spews toxic gas or chemical pesticides to do the weed removal.

Lately however conscious of on going deterioration of nature right before our eyes along with finding us the human beings at the top of endangered species, prime example being holes in ozone layer and smog and chemically contaminated water, and finally we started to change our wayward ways. We started to look for ways and means to do it non-chemically or at best to pay more attention to back to nature ways working with hand tools.

Only problem is that many hand garden tools have remained in more or less same antiquated century old designs to this day. Especially those dealing with weed removal. Mostly they are made so the person is in close quarters with the ground, which meant mostly working with bent back or crawling on hands and knees Those few innovations that came forward didn't quite work well to fend off physical discomfort or tools that came short of being helpful, starting from weed removal to disposal. And more often than not, it requires several tedious and backbreaking efforts to remove weeds off a garden or a yard.

A typical weed removing tools available has been either very flimsy or too much work consuming, not affordable to be used everyday or on the heavily affected spot.

There are many varieties of these tools; some have short hand held metal pokers with V-cut tip that forces you to work on your hands and knees. Some come in fancy metal wire shaped to wrap around weeds that will break off on hard impact to a hard rock and some that can not be used for large grown weeds on hard soil.

Others have well meaning watering snout prong shaped to be hooked up to water hose and then pushed into the ground to wet the soil around weed roots and then manually pull the weed out on your hands and knees

Others have a V-pronged metal with bowl shaped lever for catching the weeds at the neck and pulling the weed that doesn't work on buds or full-grown weeds. This tool tends to either strip or cut the weeds entirely at it's neck or cut It's roots too close to ground surface.

And then there's a tool utilizing inch size pipe to push down over the weed into the ground few short inches and hope to pull it out along with a hole in the ground that needs to be filled back in creating more work for the gardener, while pushing the compacted dirt back out of the pipe is no easy task either, and the tool is prone to breakage. It is rather a cumbersome approach to removing weed for if there were to be a large numbers of weeds in one small area or gravel soil or full grown weeds there's just no way to really do anything about it except get a shovel.

All of above shortcomings explained renders these tools totally ineffective and useless. It is found that weeds tend to grow congregated in a small space more often than not. Which makes weed removal such a painstaking work.

As can be noticed from above list of weed removal tools they all have one thing or two in common. They are made to work on a very limited range of weeds and do them very poorly. Either they are built very weak and break easily and not reliable for rough and tough yard work or not practical enough to remove every size or shaped weeds, none have been found to really work on little inch size buds, which left alone, soon in short few days will grow into a full grown weed, tall and wide with thick roots. What to do about it ?

Oftentimes it is far better to turn entire soil over with shovel than trying to remove them with these antiquated and limited tools. Also, it is not possible to do any other garden work with these tools because they are made for one thing and one thing only and do them very badly at that too. And then there are other tools like rakes, hoes, planters, pokers, cutters, gloves, long poles for grabbing or pulling shrubs and debris. And it is therefore necessary to carry around a slew of full size tools to do even a small garden work. Not only it is cumbersome to carry these tools around and store them when finished, it is also costly to have pay for them.

It is with this in mind that this new revolutionary tool was designed To begin with, it's main tool embodiment alone serves as 11 different and highly useful multi-tool functions all by itself, in that, (1) it's a bevel edged cutting blade for poking and piercing, (2) it's a digger with a long blade, (3) it's blade tip is a scraper, (4) it's blade tip is fashioned in T shape to enable it for catching and pulling weeds, twigs, vines, twines etc., (5) it has an automatically moving grab-arm complete with clamping grab plates replete with serrated edges for catching and grabbing objects from as small and thin as paper to as large as gallon jug, (6) it's a return spring loaded catcher and/or grabber for automatic movement connected to a sliding manual control for that extra grabbing power whenever it's needed, (7) that same said sliding manual control also opens and releases objects caught held in its catching and grabbing plates to free up hands from ever touching the said objects, (8) it's an extension bar with catching and holding mechanism light weight enough to be held in hands to reach objects out of arms reach, (9) it's a weed cutter armed with a blade that can cut and pulverize roots deep into the ground, (10) it's a weed grabber that provides effortless collection of loose weeds immediately after cutting, (11) It's a literally pick and up and hold and carrying tool.

Moreover it's a main shaft for any number of handy tool head attachments which will increase further its use as multi-tool potential by many folds. It can be made into different size from 1.5-5.6 foot in length having other combinations of bigger, small, wider, making it a real universal multi-function tool.

There are many types of plants we consider pests such as long rooted Thistles, Dandelions, Crabgrass, Milkweeds, and shallow roots Leafy spurge, Bird weed, Plantains, Azaleas, Rhododendrons, etc. causing concern to all gardeners. Typically these plants grow very fast, from inch size buds to several feet tall and equally wide in a matter of few short hot summer days, and they tend to grow congregated in a small given area making removal particularly a difficult task. Long rooted weeds are troublesome because part of the root can grow back easily if not cut deep enough. Shallow rooted plants are oftentimes too large and wide spread that hand pulling or small tools cannot remove them effectively.

None of existing tools have all around capabilities to remove weeds found in these extreme conditions everywhere. All of these tools are made to work mostly on those weeds growing alone isolated in a soft wet or on sandy loose and soft soil. Most of them have one workable function or the other but in terms of a hand operated garden tool or a yard working tool for removing and/or extracting weeds with minimum disturbance to the grass soil none shows any promise. Some will have cutting ability, some will do the digging, some will catch objects, some will transform and resemble into another tool, and some tries to incorporate several functions into a same tool head that none are practical and most of them will only remove mid size weeds. All of these tools have failed in providing a simple time and effort saving semi-automatic mechanism. None of them is intuitive. None of them provides any type of working blade with some length to give it real digging ability to work the soil and a means to catch what's been cutoff without creating large holes or cosmetic surface damage.

What's worse with those tools above is that once weeds are cut there is no recourse to further digging into the ground for more vigorous removal or destruction of remaining roots without creating large soil and grass damage around the subject weed. Because these tools have no apparatus for digging into the ground specifically targeting weed roots that their ultimate use is met with frustration and half finished jobs.

On top of that, once they are cut, there are tedious and possibly harmful secondary manual handling involved. Asides from having to pick loose weeds up for disposal by hands, followed by refilling holes in the grassy ground or largely damaged ground area by such clumsy tools is definitely no fun. In the mean time we risk of having another of greater chance exposure of hands to harms such as prickly thorns from some of hardy plant or sharp and dirty objects in the soil or trash area.

All these maneuvers require a lot of hard works bending down and on your knees. An activity fast becoming very physically challenging often only after few weed removals. So, this unpleasant working environment forces a person to turn to a simpler but more dangerous chemical weed killer sprays. I've had to bury many a rabbits I raised in my own back yard that died soon after ingesting some of these unwittingly poisonous grass from neighbor's yards.

Oftentimes it is far better again, to turn entire section of yard over with shovel than trying to remove them with these antiquated and limited tools. Also, it is not possible to do any other garden work with these tools because they all are non-interactive tools it is with this in mind that any new tool must be designed. The dilemma is how to make a tool that will do a variety of jobs with a minimum effort interactively while providing options of working posture standing up or not

To begin with, what was found to be needed was a long sturdy cutting knife blade attached to a long shafted handle with return spring assisted clamping mechanism that automatically opens and closes to grab cut loose weeds whenever the blade goes into or comes out of ground, and preferably there's a manual control located near the handle grip to further assist opening or grabbing action. This new tool should be useful for multitasking as well as stand-alone.

Preferably the tool should be able to work with the tool blade only on standalone basis for doing a lot of poking and cutting or scraping or slicing, or use only-its grabbing mechanism to pick up small debris and loose trashes such as bottles, cans, papers, weeds, leaves etc. or other things at out of arms reach, or to use it with both together to cut, slice, and grab, pick up, and in this case, mostly for the job it was intended for, cutting and grabbing weeds, and be able to add on various headpiece attachments so it turns into a rake, hoe, planter, etc. These attachments should also be very easy to put on and take off.

For this reason it can easily be understood the need for minimization of all of the various constraints providing an intuitive but rugged tool system that's highly portable and very economical for mass usage going into 21st century where we need to cut down on our dependency on poisonous chemicals. And for this end that this novel invention was created.

### VARIATIONS

This entire device configuration can be made utilizing various types of materials provided it is strong enough to withstand stress encountered in the working environment. Length and width or weight or thickness of the finished components or parts thereof are to directly correspond to users requirements.

There are many different kinds of add-on replaceable attachments to turn it into totally different tool yet maintaining original function of this invention to meet the need of a gardener. Also, there are various attachment methods that can be utilized to secure replaceable units stemming from existing platform of this invention. Plus, any inside components can be made to be on the outside or vice-versa, all depending on users requirements. Although said preferred embodiment methods should lend itself to a useful tool for quick and easy placement and repair.

This device is a multi-purpose tool very useful for gardening plus ability for other simple yard chores but mainly used for removing weeds with minimum damage to the soil without having to touch weeds, even those out of reach by hands.

Various alterations and modifications may be made to the foregoing without departing from the scope of this invention, as set forth following claims.

I claim:

1. A multiple function semiautomatic weed cutting and grabbing apparatus:
Novel invention equipped with blade and levered clamp for cutting and grasping in a single motion, of pushing and pulling, wide T-shaped blade tip is effective in cutting on forward motion and catching plant vines on reverse motion the and wide clamp surface is effective for grabbing weeds and plants and plurally grabbing other objects:
Lever of said levered clamp moves in conjunction with blade motions, blade is pushed into ground concurrently forcing the levered clamp to open up, pulling the blade out of ground allows the said levered clamp to close down accordingly until two clamp surfaces meet. The said lever also has a separate manual interruption for opening and closing of grasping contact area without affecting blade motion thus resulting in multi-purpose semi-automatic apparatus. This refined reciprocating motions of blade and lever allows multiple weeds to be cut and contained thereby within its grasp: Wherein invention comprises:
Where there's first implement lever means having an upper end adapted to being an top part of two part grasping clamp and an opposed lower end adapted to pivot and generally rigid elongate member adapted to a limited relative movement urged by guide means whose movement is derived from fourth implement control means generally rigid elongate member with all bottom lower end of impact receptor means generally wide rigid member adapted to to resist ground penetration urge and top lower end generally wide rigid member adapted to being an bottom part of said two part grasping clamp and an top upper end a guide means generally wide rigid member adapted for receiving and/or transferring longitudinal forces to and from other implement(s) and/or means and an opposed upper end adapted to a limited relative movement urged by movement of resiliently biasing spring means adapted to receive and store longitudinal force from said fourth implement, and from movement of second implement generally rigid elongate shaft member having hand grip on an upper end and an opposed lower end having longitudinally protruding elongate tapered tine terminating at a tip, and from movement of third implement generally rigid elongate member with limited relative movement urged by motions of operators hand, serving also as manual interruption and control means, and combinations thereof; and
top grasping part end of said first implement and bottom grasping part end of said fourth implement comes to contact through range of motion concurrent to motions of said second implement upon said tip penetrating ground, to grab loose weeds, and this motion is repeated until there are several weeds caught therebetween; and
top grasping part end of said first implement and bottom grasping part end of said fourth implement comes in contact to clamp onto each other having contact surfaces of both adapted to resist slippage; and
said third implement adapted for hand holding and manual force transferring means to force and/or interrupt motions of said fourth implement and adapted to move alongside said second implement; and
hand grip at an upper end of said second implement adapted for hand holding; and an end of said fourth implement has members adapted to impede attachment of foreign materials and provide clearance for continued unhindered movement of said elongate tapered tine of said second implement; and
elongate tapered tine terminating at tip of said second implement adapted to ground penetration and/or piercing, and having protrusion(s) for and/or catching foreign materials; and
elongate tapered tine terminating at tip of said second implement with protrusions adapted to hooking onto foreign material(s); and
elongate tapered tine terminating at tip of said second implement with protrusions adapted to serrate foreign material(s); and
lower pivot end/or pivot means of said first implement and/or said second implement generally has its pivot junction and/or housing at nearer to tine tips than to an upper hand grip end, its location and distance upon elongate member of said second implement has means for longitudinal retaining of compressive spring means such that outward longitudinal biasing resiliency of said spring means provides said guide means one way longitudinal force means on rigid elongate member for clamping and/or locking up of said first implement; and
outward longitudinal biasing resiliency of said spring means provides one way movement means for said fourth implement providing one way longitudinal directional force to said guide means providing one way longitudinal force means on rigid elongate member for clamping and/or locking up of said first implement; and
said limited relative movement of said first implement urged by said spring means has a range of semicircle motion less than 180 degrees and having dimensions adapted to fit onto said second implement; and
range of motion less than 180 degrees of said first implement is provided by the movement of said fourth implement, but reciprocal motion is generally limited only to upper region near 180 degrees open position; and
longitudinal movement of said third implement provides corresponding movement means for said fourth implement providing corresponding movement means for said guide means providing corresponding movement means on rigid elongate member for clamping and/or locing up of said first implement; and
outward longitudinal biasing resiliency of said spring means at relaxed state in uncompressed position provides said guide means one way longitudinal force means on rigid elongate member for clamping and/or locking up of said first implement; and
said spring means comprising an elastic and compressible member receives compressing force means a one way movement from said four implement urged by one way longitudinal directional force coming from impact receptor means urged by resistive force to ground penetration caused by penetration of ground of elongate tapered tine terminating at tip of said second implement; and
full extension of elongate tapered tine of said second implement having projected from lower end of said fourth implement causes full compression of said spring means against pin means and/or pivot means situated on said second implement, and force of decompression of said spring is delivered to abutment portion of said fourth implement in limited relative movement providing force and motion to all connected implements and/or means of motions; and
full extension of elongate tapered tine of said second implement having projected from lower end of said fourth implement causes full compression of said spring means against pin means and/or pivot means situated on said second implement, and force of decompression of said spring is delivered to abutment portion of said fourth implement in limited relative movement providing force and motion to all connected implements and/or means of motions until said first implement stops moving; and
said second implement being telescopically disposed in said fourth implement having tapered tine portion projecting from lower end of said fourth implement, and having rigid elongate member projecting from an upper end of said fourth implement enabling limited relative motion of said second implement limited, at upper end of motion, by pivot means and/or pin means and/or binding cross point reached between guide means and fully open position elongate member of first implement; and
said second and fourth implements are generally rigid elongate members telescopically placed one within the other in close tolerance adapted for no rotational movement between two said implements and maintaining straight longitudinal sliding motion against each other; and
rigid elongate member of said fourth implement having through holes and external surrounding surface generally adapted for connection to foreign material and/or devices; and
elongate tapered tine of said second implement having through holes and external surrounding surface generally adapted for connection to foreign material and/or devices adapted for such attachment; and
elongate tapered tine terminating at tip of said second implement adapted for securing foreign devices; and
elongate tapered tine terminating at tip of said second implement adapted to be subjected to axial, lateral, rotational forces; and p1 lower pivot end and/or pivot means of said first implement and/or of said second implement generally located nearer to tine tips than to an upper hand grip end; and
rigid elongate member of said second implement has means for longitudinal retaining of compressive spring means such that outward longitudinal biasing resiliency of said spring means provides said guide means one way longitudinal force means on rigid elongate member for clamping and/or locking up of said first implement; and
movement of said fourth implement provides forces to increase resilient biasing of said spring means; and biasing resiliency of said spring means provides means for movement of said fourth implement; and
movement of said guide means providing force means upon rigid elongate member for clamping and/or locking up of said first implement; and
range of axial and/or semicircle motion of said first implement urged by spring means; and
said spring means having dimensions adapted to fit into said second implement and adapted to receive compression force in one direction and adapted to provide decompression force in opposite direction; and
range of motion less than 180 degree of said first implement is urged by movement of said fourth implement, but reciprocal motion is generally limited only to upper region of full open position of said first implement; and
movement of said third implement urges movement of said fourth implement; and
movement of said guide means of said fourth implement urging movement of said first implement; and
axial and/or semicircular movement of rigid elongate member of said first implement resulting in bringing both grasping clamp means of said first implement and said fourth implement in contact with each other for clamping and/or locking up of said first implement; and
said first implement and said fourth implement lock up to each other is in one way lock up fashion where said first implement is locked up by force upon it from said fourth implement moving in one direction whereas said fourth implement moving in opposite direction unlocks; and
outward longitudinal biasing resiliency of said spring means at relaxed state otherwise known as uncompressed position still has in it a remnant decompression force to urge said guide means to move; and
outward longitudinal biasing resiliency of said spring means at relaxed state otherwise known as uncompressed position still has in it a remnant decompression force to urge rigid elongate member of said fourth implement upon said first implement and for clamping and/or locking up; and
force of said third implement urging said fourth implement for limited relative movement urging range of motion to all connected implements and means until said first implement stops; and
elongate tapered tine terminating at tip of said second implement adapted for securing foreign devices; and
rigid elongate member of said fourth implement adapted to be subjected to longitudinal, axial, lateral, rotational forces; and
materials and/or devices adapted for attachment to said second implement and/or said fourth implement is also further adapted to replicate headpieces of varieties of garden tools; and
meaning of word surface shall mean either interior or exterior unless otherwise stated.

2. A multiple function weed cutting and grabbing apparatus in claim 1, wherein said multiple function weed cutting and grabbing apparatus has blade means adapted to turn several times under pushing force into the ground to break apart and/or pulverize plant roots.

3. A multiple function weed cutting and grabbing apparatus in claim 1, wherein said multiple function weed cutting and grabbing apparatus said fourth implement and said second implement includes a set of multiple, longitudinally set protrusions spaced apart adapted to accept snap in of said headpieces.

4. A multiple function weed cutting and grabbing apparatus in claim 1, wherein said multiple function weed cutting and grabbing apparatus having said handle and/or shaft adapted to operate up to six feet long and also having length of said cutting-blade adapted for penetration up to eight inches.

5. A multiple function weed cutting and grabbing apparatus in claim 1, wherein said multiple function weed cutting and grabbing apparatus having said having third implement fashioned in small protrusion on pivot attached transversally to said fourth implement further adapted as trigger for placing finger(s) located on or near said upper hand grip of said second implement attached by connector to said fourth implement forcing movements, wherein said trigger with said connector adapted to keep said trigger free except for transferring pulling force upon finger pull.

6. A multiple function weed cutting and grabbing apparatus in claim 1, wherein said multiple function weed cutting and grabbing apparatus has protrusions on said impact receptor means adapted to provide fulcrum action positioned near bottom end of said fourth implement.

7. A multiple function weed cutting and grabbing apparatus in claim 1, wherein said multiple function weed cutting and grabbing apparatus where all of said implements and all of said means and any variations thereof are fashioned out of any material that's able to withstand required stress for a given job.
